(19) United States
(12) Patent Application Publication
(10) Pub. No.: US 2024/0136104 A1
(43) Pub. Date: Apr. 25, 2024

(54) CORRUGATED RADIATOR FOR TRANSFORMER

(71) Applicant: SANIL ELECTRIC CO., LTD., Ansan-si, Gyeonggi-do (KR)

(72) Inventor: Seonggyu Baek, Anyang-si (KR)

(73) Assignee: SANIL ELECTRIC CO., LTD., Ansan-si, Gyeonggi-do (KR)

(21) Appl. No.: 18/547,900

(22) PCT Filed: Dec. 22, 2021
(86) PCT No.: PCT/KR2021/019570

§ 371 Date: Aug. 24, 2023

(30) Foreign Application Priority Data
Mar. 9, 2021 (KR) 10-2021-0030868
Mar. 9, 2021 (KR) 10-2021-0030869

(51) Int. Cl. H01F 27/12

(52) U.S. Cl. CPC H01F 27/12

(57) ABSTRACT

A corrugated radiator for a transformer includes: a first flow path tube which receives insulating oil from a transformer main body; a second flow path tube through which insulating oil that finished the heat exchange with the outside flows into the transformer main body; and a corrugated fin block which has an inner space communicating with the first and second flow path tubes and receives the insulating oil, wherein the corrugated fin block is formed so that connecting portions connecting heat dissipation fins face each other to form a closed structure for circulating the insulating oil. According to the present technology, limitations due to an installation space of the radiator can be overcome and a plurality of heat dissipation fins can be effectively manufactured.

### TECHNICAL FIELD

The present invention relates to a corrugated radiator for a transformer, and more particularly, to a radiator for a transformer to which a corrugated heat dissipation fin is applied.

### BACKGROUND ART

A transformer generates a lot of heat when operating. Therefore, a structure that dissipates heat efficiently is very important in the design of a transformer.

A radiator may be applied to the transformer to dissipate heat. The radiator has a large number of heat dissipation fins arranged closely together to increase an area of heat exchange.

Since increasing heat dissipation efficiency is the key, there are various approaching ways, such as studies on structural changes, such as installing dents in the heat dissipation fins, or studies on reorienting the arrangement of the heat dissipation fins.

Korean Utility Model Registration No. 20-0348854 (entitled “Radiator for a Transformer”) is directed to providing a radiator for a transformer including a pair of header pipes installed parallel to each other on one side of a transformer main body, and a plurality of heat dissipation plates communicatively installed between the header pipes, wherein the heat dissipation plate has a space formed therein by joining edges of two plates, and a plurality of groove portions are formed so that the two plates are in contact with each other inside the space in a lengthwise direction of the heat dissipation plate, so that an insulating oil passage is formed, and an uneven portion is formed long between the groove portions, thereby excellently improving a cooling effect.

However, conventional radiators for transformers as described above have a problem that the structure is complicated. Manufacturing of multiple heat dissipation plates is a labor-intensive process and accounts for a significant amount of work in radiator production. This increases the cost.

A task of individually attaching a large number of heat dissipation plates to the header pipes also consumes a significant amount of resources. Moreover, a size of the heat dissipation plates is typically dependent on a size of the transformer, so that the number of heat dissipation fins is limited by an installation area. A task of attaching a large number of heat dissipation plates only in predetermined positions significantly reduces spatial efficiency.

The inventor of the present invention has conducted extensive research and gone through a series of trial and error in order to overcome space constraints and develop a more efficient manufacturing method. This effort has ultimately led to the completion of the present invention.

### Technical Problem

The present invention is directed to providing a corrugated radiator for a transformer that is capable of overcoming limitations due to an installation space and manufacturing a plurality of heat dissipation fins more efficiently.

Meanwhile, other objects, which are not explicitly disclosed in the present invention, will be additionally considered within a range in which the objects can be easily derived from the following detailed description and the effects thereof.

### Technical Solution

A corrugated radiator for a transformer according to an embodiment of the present invention may include: a first flow path tube configured to receive insulating oil from a transformer main body; a second flow path tube through which the insulating oil, which has finished heat exchange with the outside, flows into the transformer main body; and a corrugated fin block having an inner space communicating with the first and second flow path tubes and configured to receive the insulating oil, wherein the corrugated fin block may be formed so that connection portions connecting heat dissipation fins face each other to form a closed structure for circulating the insulating oil.

The connection portions may form an insulating oil flowing channel between the first and second flow path tubes.

The corrugated fin block may include a first corrugated fin portion disposed on one side, and a second corrugated fin portion disposed on the other side with respect to the channel, the connection portions may include a first connection portion configured to integrally connect heat dissipation fins of the first corrugated fin portion, and a second connection portion configured to integrally connect heat dissipation fins of the second corrugated fin portion, and the first connection portion and the second connection portion may be disposed to face each other.

The connection portions may further include a bent portion configured to integrally connect the first connection portion and the second connection portion.

The first flow path tube may include both first extensions configured to form a first opening along the channel, the second flow path tube may include both second extensions configured to form a second opening along the channel, and the connecting portions may be disposed on outer sides of the both first extensions and the both second extensions in a state in which the corrugated fin block is coupled to the first and second flow path tubes.

The heat dissipation fin and the connection portions may be integrally molded from a single panel and continuously formed.

The heat dissipation fins of the first corrugated fin portion and the heat dissipation fins of the second corrugated fin portion may be arranged side by side with each other.

The heat dissipation fins of the first corrugated fin portion and the heat dissipation fins of the second corrugated fin portion may be spaced apart from each other by a width of the channel.

The corrugated radiator may further include a first interval maintaining portion coupled to an outer side of the first corrugated fin portion to maintain a predetermined interval of the heat dissipation fins, and a second interval maintaining portion coupled to an outer side of the second corrugated fin portion to maintain a predetermined interval of the heat dissipation fins.

A corrugated fin elongated radiator for a transformer according to another embodiment of the present invention may include: a first flow path tube configured to receive insulating oil from a transformer main body; a second flow path tube through which the insulating oil, which has finished heat exchange with the outside, flows into the transformer main body; two or more corrugated fin blocks each having an inner space communicating with the first and second flow path tubes and configured to receive the insulating oil; and one or more connection blocks configured to form a space to receive the insulating oil between the corrugated fin blocks.

The corrugated fin blocks may be formed so that connection portions connecting heat dissipation fins face each other to form a closed structure for circulating the insulating oil.

The connection portions may form an insulating oil flowing channel between the first and second flow path tubes.

Each of the corrugated fin blocks may include a first corrugated fin portion disposed on one side, and a second corrugated fin portion disposed on the other side with respect to the channel, the connection portions may include a first connection portion configured to integrally connect heat dissipation fins of the first corrugated fin portion, and a second connection portion configured to integrally connect heat dissipation fins of the second corrugated fin portion, and the first connection portion and the second connection portion may be disposed to face each other.

The connection portions may further include a bent portion configured to integrally connect the first connection portion and the second connection portion.

The first flow path tube may include both first extensions configured to form a first opening along the channel, the second flow path tube may include both second extensions configured to form a second opening along the channel, and the connection block may include two opposite plate portions configured to form a third opening and a fourth opening facing the third opening along the channel.

The connecting portions may be disposed on outer sides of the both first extensions and the both second extensions in a state in which the corrugated fin blocks are coupled to the first and second flow path tubes, and the connecting portions may be disposed on outer sides of the two opposite plates in a state in which the connection block is coupled to the corrugated fin blocks.

The heat dissipation fin and the connection portions may be integrally formed from a single panel and continuously formed.

The heat dissipation fins of the first corrugated fin portion and the heat dissipation fins of the second corrugated fin portion may be arranged side by side with each other.

The heat dissipation fins of the first corrugated fin portion and the heat dissipation fins of the second corrugated fin portion may be spaced apart from each other by a width of the channel.

The corrugated fin elongated radiator may further include a first interval maintaining portion coupled to an outer side of the first corrugated fin portion to maintain a predetermined interval of the heat dissipation fins, and a second interval maintaining portion coupled to an outer side of the second corrugated fin portion to maintain a predetermined interval of the heat dissipation fins.

The corrugated fin elongated radiator may further include a reinforcing plate disposed side by side with the connection block, wherein the reinforcing plate may be coupled to the first interval maintaining portion of any one of the two or more corrugated fin blocks and to the first interval maintaining portion of the other one of the two or more corrugated fin blocks to support a self-weight.

The connection block may have a plurality of reinforcing ribs therein.

### Advantageous Effects

The present technology can provide a corrugated radiator that is capable of overcoming limitations due to an installation space and manufacturing a plurality of heat dissipation fins more efficiently.

In addition, the present technology can provide a corrugated fin elongated radiator for a transformer that is capable of overcoming limitations due to an installation space and manufacturing a plurality of heat dissipation fins more efficiently.

### DESCRIPTION OF DRAWINGS

FIG. 1 is a view illustrating an overall configuration of a corrugated radiator for a transformer according to an embodiment of the present invention.

FIG. 2 is an exploded view illustrating the corrugated radiator for a transformer according to the embodiment of the present invention.

FIG. 3 is a view illustrating in more detail a corrugated fin block of the corrugated radiator for a transformer, according to the embodiment of the present invention.

FIG. 4 is a view illustrating an example of forming the corrugated fin block according to the embodiment of the present invention.

FIG. 5 is a view schematically illustrating a process for manufacturing the corrugated fin block in FIG. 4.

FIG. 6 is a view illustrating a detailed configuration of a first flow path tube according to the embodiment of the present invention, in which FIG. 6A is a perspective view and FIG. 6B is a perspective view when viewed from a bottom side.

FIG. 7 is a view illustrating a coupling relationship between the first flow path tube and the corrugated fin block, according to the embodiment of the present invention.

FIG. 8 is a view illustrating an overall configuration of a corrugated fin elongated radiator for a transformer according to the embodiment of the present invention.

FIG. 9 is an exploded view of the corrugated fin elongated radiator for a transformer according to the embodiment of the present invention.

FIG. 10 is a view illustrating a coupling relationship between a connection block and corrugated fin blocks according to the embodiment of the present invention.

The accompanying drawings are illustrated as a reference for understanding the technical idea of the present invention and do not limit the scope of the rights of the present invention.

### MODES OF THE INVENTION

Hereinafter, the most preferred embodiments of the present invention are described. In the drawings, the thickness and interval are expressed for descriptive convenience only and may be exaggerated relative to the actual physical thickness. In describing the present invention, the known configurations that are not relevant to the subject matter of the present invention may be omitted. In assigning reference numerals to constituent elements of the respective drawings, it should be noted that the same constituent elements will be designated by the same reference numerals, if possible, even though the constituent elements are illustrated in different drawings.

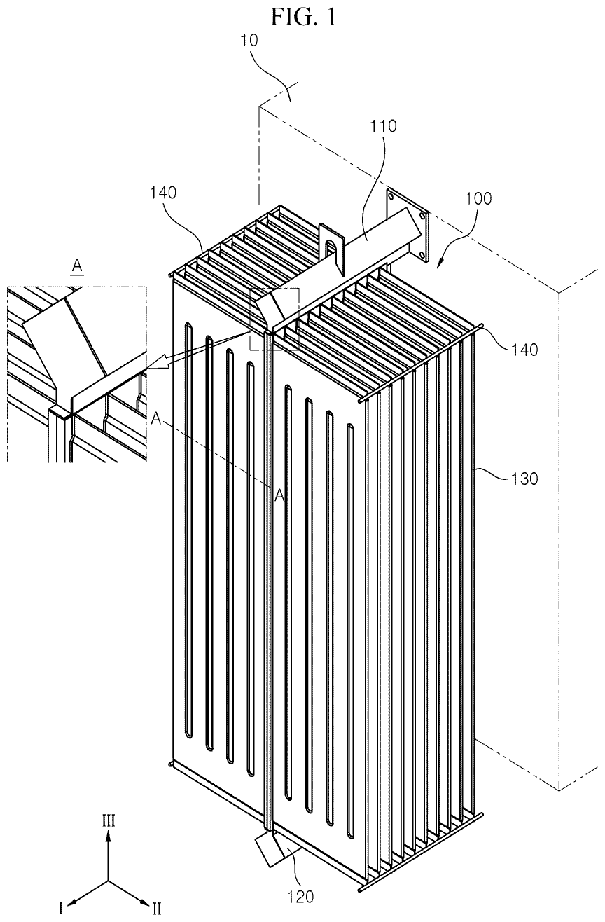

FIG. 1 is a view illustrating an overall configuration of a corrugated radiator for a transformer according to an embodiment of the present invention.

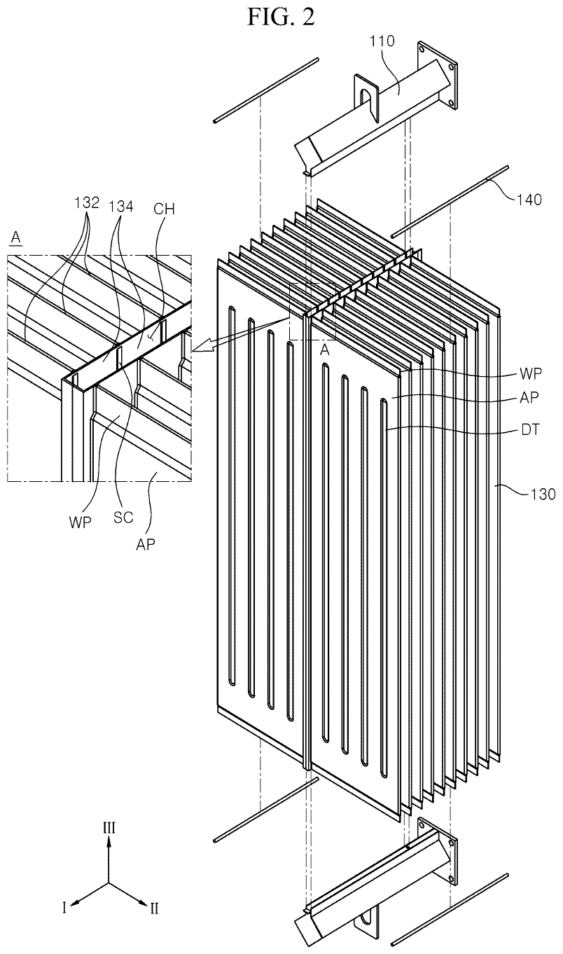

FIG. 2 is an exploded view illustrating the corrugated radiator for a transformer according to the embodiment of the present invention.

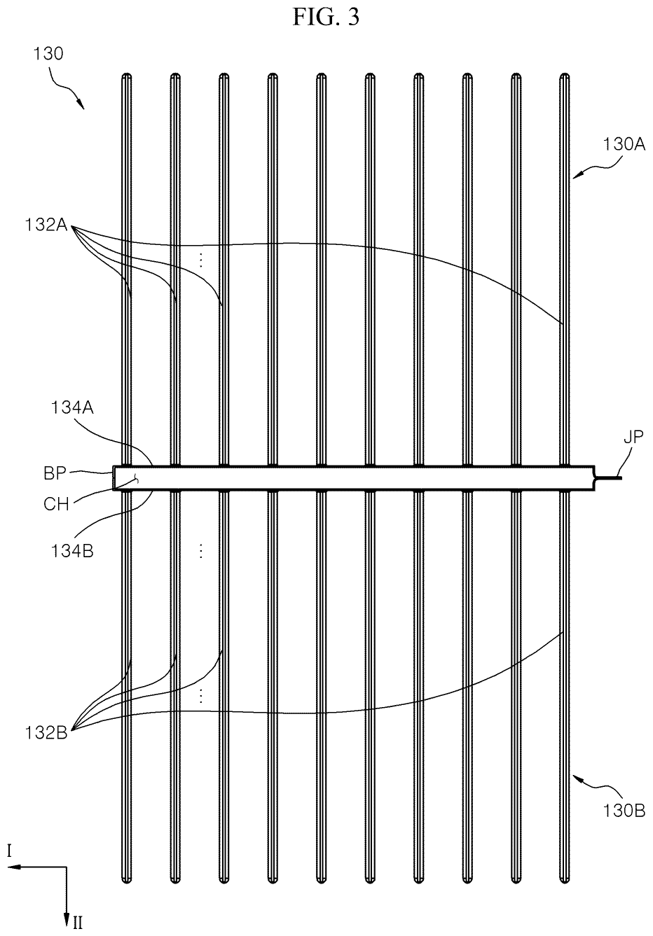

FIG. 3 is a view illustrating in more detail a corrugated fin block of the corrugated radiator for a transformer, according to the embodiment of the present invention.

With reference to FIGS. 1 to 3, a corrugated radiator for a transformer 100 (hereinafter simply referred to as a “corrugated radiator” or “radiator”) may include a first flow path tube 110, a second flow path tube 120, a corrugated fin block 130, and an interval maintaining portion 140.

The first flow path tube 110 receives insulating oil from a transformer main body 10.

The transformer main body 10 may be a power transformer, a distribution transformer, a pole-type transformer, a ground-type transformer, or an autotransformer. The present invention is not limited to the examples listed, and it can be applied to any type of transformer where the cooling method using fluid is employed. The fluid may be any heat transfer medium, including but not limited to transformer oil, insulating oil, a coolant, air, etc. However, for convenience of description, the present invention will be focused on an embodiment in which fluid is insulating oil.

The second flow path tube 120 flows the insulating oil that has finished heat exchange with the outside to the transformer main body.

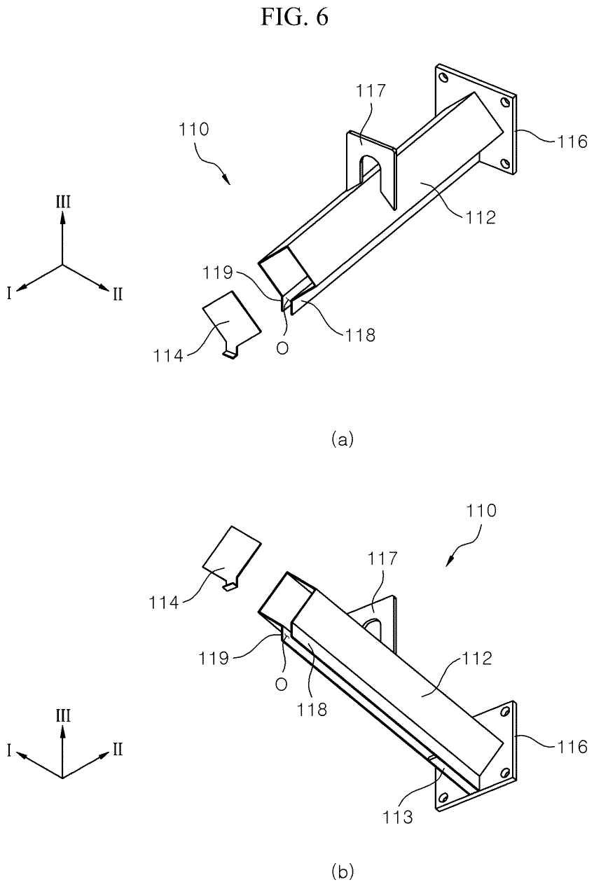

The first flow path tube and the second flow path tube may be in the form of a pipe through which the insulating oil may flow therein. In the drawings, the first and second flow path tubes extend in a first direction I. As will be described below, each of a lower portion of the first flow path tube and an upper portion of the second flow path tube has an opening (O, in FIG. 6). The opening also extends in the first direction to form a flow passage for the insulating oil.

The corrugated fin block 130 is disposed between the first flow path tube 110 and the second flow path tube 120.

The corrugated fin block 130 has an inner space communicating with the first flow path tube 110 and the second flow path tube 120 to receive the insulating oil (not illustrated).

The corrugated fin block forms an insulating oil flowing channel CH in a center of the corrugated fin block. Therefore, a circulation path is formed in which the insulating oil sequentially passes through the first flow path tube, the corrugated fin block, and the second flow path tube. That is, the insulating oil that gains heat from the transformer main body 10 exits the first flow path tube 110, passes through the corrugated fin block 130 to dissipate heat, and enters the transformer main body again through the second flow path tube 120 to circulate inside the radiator.

The insulating oil is a heat transfer medium, including but not limited to any form of fluid such as oil, or the like. It is enough to serve as a heat pump to dissipate heat away from the transformer main body.

The corrugated fin block 130 includes heat dissipation fins 132.

Each of the heat dissipation fins 132 extends in a second direction II in the drawings. The heat dissipation fins have a height in a third direction III.

A sub-channel (SC, see an enlarged view of part A in FIG. 2) is formed inside each heat dissipation fin. The sub-channels are formed by the number of heat dissipation fins. Several sub-channels SC may have a branch-like shape extending from the insulating oil flowing channel CH. The insulating oil is received inside each heat dissipation fin to maximize an area of thermal contact with the outside air.

According to the embodiment of the present invention, as the insulating oil flowing channel CH is arranged in the center of the corrugated fin block 130, the heat dissipation fins 132 may be seen to be disposed along an outer periphery of the insulating oil flowing channel CH. Alternatively, the heat dissipation fins 132 may be seen as being spaced apart at predetermined intervals with the insulating oil flowing channel CH in the center of the heat dissipation fins. In this case, the predetermined interval may be a width of the insulating oil flowing channel CH in the second direction II.

In the drawings, 10 heat dissipation fins on one side and 10 heat dissipation fins on the right side are illustrated, totaling 20, but the present invention is not limited to the number of fins. The heat dissipation fins may be formed in various numbers depending on a width of the heat dissipation fin, an interval between the heat dissipation fins, and a thickness of a material forming the heat dissipation fin.

The corrugated fin block 130 according to the embodiment of the present invention includes connection portions 134 that connect the heat dissipation fins 132.

With reference to FIG. 3, when the corrugated fin block 130 includes a first corrugated fin portion 130A disposed on one side and a second corrugated fin portion 130B disposed on the other side with respect to the insulating oil flowing channel CH, the heat dissipation fins (first heat dissipation fins) of the first corrugated fin portion 130A may be referred to by the reference numeral 132A and the connection portion (a first connection portion) may be referred to by the reference numeral 134A, respectively. The heat dissipation fins (second heat dissipation fins) of the second corrugated fin portion 130B may be referred to by reference numeral 132B and the connection portion (a second connection portion) may be referred to by reference numeral 134B, respectively.

The first connection portion 134A may integrally connect the first heat dissipation fins 132A. The second connection portion 134B may integrally connect the second heat dissipation fins 132B.

The heat dissipation fins 132A of the first corrugated fin portion and the heat dissipation fins 132B of the second corrugated fin portion may be arranged side by side with each other.

In this case, the first connection portion 134A is disposed to face the second connection portion 134B.

The first connection portion and the second connection portion may be seen as being spaced apart at predetermined intervals with the insulating oil flowing channel CH in the center of the heat dissipation fins. In this case, the predetermined interval may be the width of the insulating oil flowing channel in the second direction II.

As illustrated in the drawings, the first connection portion forms a wall portion that forms a closed structure for circulating insulating oil. The second connection portion forms an opposite wall portion forming the closed structure for circulating insulating oil. That is, the first connection portion and the second connection portion are formed to face each other to form the closed structure for circulating the insulating oil.

That is, the connection portions 134A and 134B form the insulating oil flowing channel CH between the first flow path tube 110 and the second flow path tube 120.

In addition, as illustrated in the drawings, the first connection portion 134A and the second connection portion 134B may be connected to each other by a bent portion BP. The bent portion may continuously connect the first connection portion and the second connection portion in a seamless manner. The bent portion may integrally connect the first connection portion and the second connection portion.

The bent portion BP forms another wall portion that forms the closed structure for circulating the insulating oil.

The first connection portion 134A and the second connection portion 134B may be connected to each other by a joint portion JP on an opposite side of the bent portion. The joint portion may be a portion in which the discontinued first and second connection portions are bonded to each other by a physical method such as welding or a chemical method. Without being limited to this, it is also possible to connect the first connection portion and the second connection portion to each other by adding a separate joint structure.

The joint portion JP forms another opposite wall portion that forms the closed structure for circulating the insulating oil.

Accordingly, the insulating oil flowing channel CH may be a cuboidal space elongated in the third direction III created by the first connection portion and the second connection portion facing each other, and by the bent portion and the joint portion facing each other.

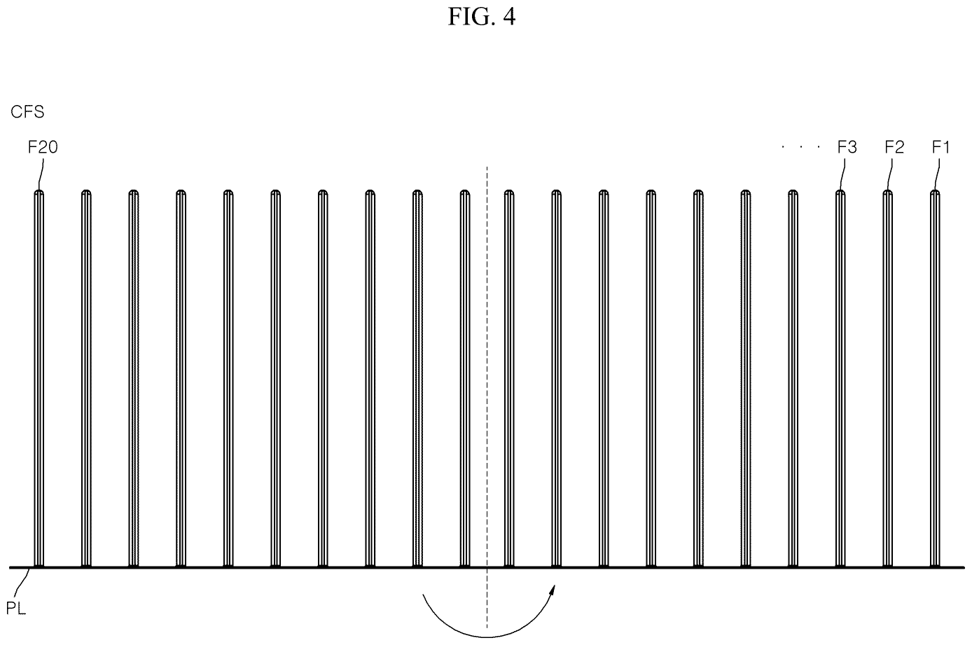

FIG. 4 is a view illustrating an example of forming the corrugated fin block according to the embodiment of the present invention.

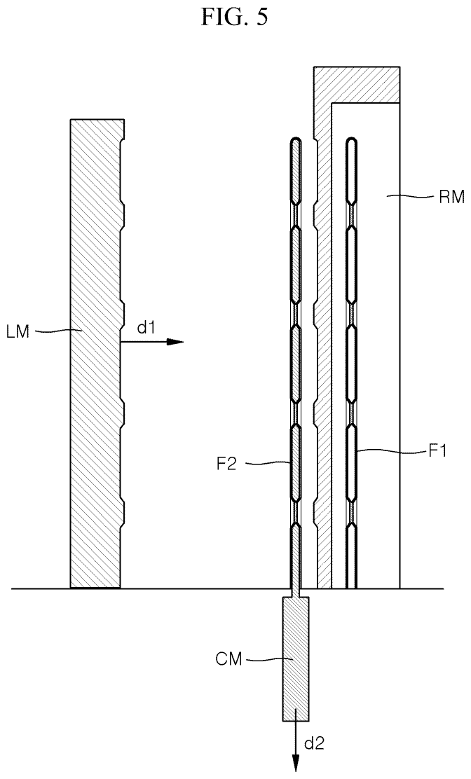

Further, FIG. 5 is a view schematically illustrating a process for manufacturing the corrugated fin block in FIG. 4.

First, with reference to FIG. 4, the corrugated fin block according to the embodiment of the present invention may be formed by bending a corrugated fin portion CFS integrally molded from a single panel PL once in the middle.

A portion bent in the middle becomes the bent portion BP described above.

A total of 10 fins from a rightmost fin F1 to the left in the drawing constitute the first corrugated fin portion 130A described above.

A total of 10 fins from the next fin to a leftmost fin F20 in the drawing constitute the second corrugated fin portion 130B described above.

In the drawing, a right end and a left end of the panel meet and are joined to form the joint portion JP described above.

With reference to FIG. 5, a process of obtaining the above-described corrugated fin portion CFS from the single panel PL is illustrated.

As illustrated in FIG. 5, the corrugated fin portion CFS may be manufactured through a press process using a mold. A left mold LM, which is a moving end, enters a right mold RM, which is a fixed end, in a direction dl. Before this process, a core mold CM pushed the panel upward and deformed the panel. As the left mold LM firmly presses the panel toward the right mold RM, the panel is manufactured to the fin F1 in the shape described above. The panel that has finished the deformation moves slightly to the right, and new fins F2 to F20 may be manufactured sequentially.

When a cross section is taken along line AA in FIG. 1 described above, it can be seen that the fin F1 in the shape of FIG. 5 is obtained.

Meanwhile, the corrugated fin block 130 may be formed in a variety of ways, without being limited to the manufacturing example described above in FIGS. 4 and 5.

For example, rather than being folded, the first corrugated fin portion and the second corrugated fin portion may be formed separately and then joined to form the shape illustrated in FIG. 3. Instead of the bent portion on the left in the drawing, another joint portion that is the same as the joint portion described above may be disposed. That is, the first corrugated fin portion having 10 fins and the second corrugated fin portion having 10 fins may be formed separately and then joined to each other by joint portions on both sides to have the shape illustrated in FIG. 3.

According to the manufacturing method of the corrugated fin block described in FIGS. 4 and 5, the heat dissipation fins may be integrally formed to promote structural stability, manufacturing convenience, and cost savings. The thickness of the heat dissipation fin and the interval between the heat dissipation fins may be easily changed from the thickness of the panel that is a raw material, the thickness of the mold, and the size, making it easier to manufacture the required number of heat dissipation fins in a limited space.

With reference back to FIG. 2, the heat dissipation fin 132 has a dent portion DT that is concave in a center thereof. The dent portion may be an oil-free area. Alternatively, the dent portion is also a portion that serves as an oil conservator that may receive some oil upon deformation due to an increase in internal pressure. In the drawings, a total of four dent portions extend along the third direction on one heat dissipation fin, but the present invention is not limited to the number or shape thereof. In contrast, a portion that receives oil is illustrated in the drawing as an accommodation portion AP. The accommodation portion determines the thickness of the heat dissipation fin.

The heat dissipation fin 132 may form an inner space (i.e., the sub-channel SC, described above) capable of receiving the insulating oil by joining an uppermost end and a lowermost end of the heat dissipation fin 132 in the drawing by welding or the like. In the drawing, an uppermost welded portion is referenced by the reference numeral WP.

Meanwhile, an end far from the center channel CH is naturally formed by the press process as described above in FIGS. 4 and 5, and therefore no separate joining is required.

The interval maintaining portion 140 is formed in the shape of a rod and coupled to the heat dissipation fins to allow the heat dissipation fins to maintain a predetermined interval.

As illustrated in the drawings, the interval maintaining portion may be disposed at each of edges of the corrugated fin block, thus a total of four interval maintaining portions may be disposed. One interval maintaining portion may be disposed to be welded to all of the uppermost welded portions (WP, see FIG. 2) of each of the heat dissipation fins. When exposed to repeated expansion and contraction of the insulating oil (especially in transformers applied to solar power generators, where the power output can vary significantly over time), the original shape of the heat dissipation fins may not be maintained, and the interval between the heat dissipation fins may become distorted. To address this issue, the interval maintaining portion is disposed at this joining position with the least risk of insulating oil leakage on the heat dissipation fins manufactured through the press process using the mold, as described above. This enables the introduction of a more stable interval maintenance structure.

FIG. 6 is a view illustrating a detailed configuration of the first flow path tube according to the embodiment of the present invention. FIG. 6A illustrates a perspective view and FIG. 6B illustrates a perspective view when viewed from a bottom side.

As illustrated in FIG. 6, the first flow path tube 110 may include a body portion 112 configured to form a space for the insulating oil to flow therein, a closing portion 114 coupled to one side of the body portion to form a closed structure, a flange portion 116 configured to couple the first flow path with the transformer main body, and a loop portion 117 configured to serve as a loop during manufacturing or transportation. The closing portion, referenced by reference numeral 114, is illustrated in an exploded state for convenience of description.

The first flow path tube has an opening O for communicating with an inner space of the corrugated fin block. The opening extends along the first direction together with the insulating oil flowing channel CH described above.

The opening O may be formed by both first extensions 118 and 119 extending in a downward direction from the body portion 112.

The opening is limited in length by a lower closing portion 113.

The lower closing portion 113 is arranged between the both first extensions 118 and 119 to close a portion of the opening. This ensures that a sealing structure is maintained even if the corrugated fin block is installed at a certain distance from the transformer main body. The lower closing portion may be in the form of a plate that is capable of closing the opening.

The same description may be applied to the second flow path tube 120 with only the disposed position being different from the first flow path tube 110 described above. That is, the second flow path tube may also include both second extensions that form an opening along the insulating oil flowing channel. In addition, the second flow path tube may have a body portion, a closing portion, a flange portion, and a loop portion. The second flow path tube may have an upper closing portion instead of the lower closing portion. A more detailed description is omitted.

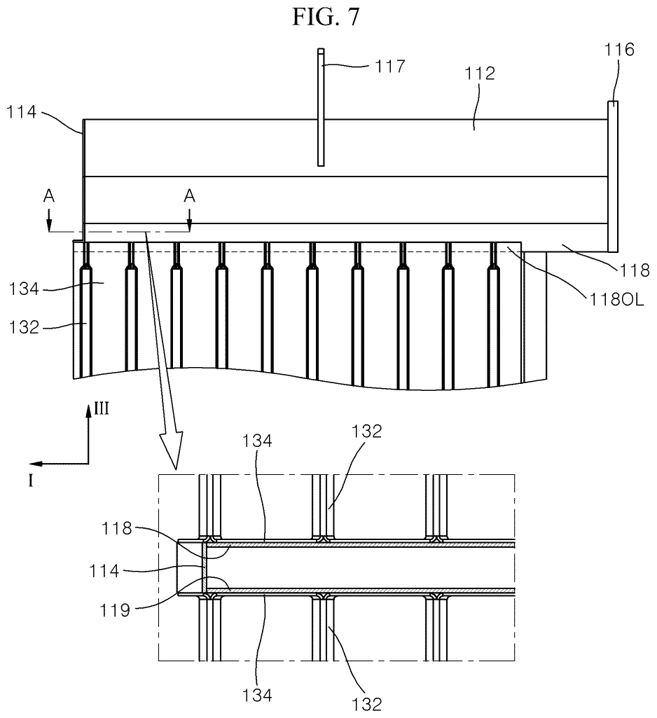

FIG. 7 is a view illustrating a coupling relationship between the first flow path tube and the corrugated fin block, according to the embodiment of the present invention.

With reference to FIG. 7, the first flow path tube 110 may be coupled in a manner in which the first flow path tube 110 is inserted into the corrugated fin block 130.

In detail, the first path tube may be coupled in such a way that a portion of the both first extensions of the first flow path tube is inserted into the insulating oil flowing channel arranged in the center of the corrugated fin block.

After being inserted, the first path tube may be firmly fixed by a physically joining method, such as welding or the like, or a chemically joining method. For example, the welding may be applied to an outer surface of the connection portion that is disposed on the outside of the both first extensions 118 and 119 that are in a state of being inserted into the insulating oil flowing channel.

An area overlapped by the insertion is referenced in the drawing by the reference numeral 1180L. Although not illustrated, there may be an equally overlapping area on the other side. The reference numeral 1180L is used to represent an element 118 that is disposed inside the connection portions.

With reference to an enlarged view according to a cross section taken along line AA in FIG. 7, the arrangement relationship between the both first extensions 118 and 119 and the connection portion 134 of the corrugated fin block in the insulating oil flowing channel may be seen. The both first extensions may be inwardly attached to the connection portions. It is preferred that the connection portions and the both first extensions are in close contact with each other so as to form a circulation path of the insulating oil.

This structure is advantageous for welding and joining the first flow path tube to the corrugated fin block manufactured through the press process. That is, in consideration of the characteristic of the corrugated fin block being molded integrally from the single panel, the both first extensions of the first flow path tube, which are a joining portion, are disposed inside the connection portions, so that the welding operation may be performed more easily.

The coupling relationship between the first flow path tube and the corrugated fin block described in FIG. 7 may be applied equally to the coupling relationship between the second flow path tube and the corrugated fin block. That is, the second path tube may be coupled in such a way that a portion of the both second extensions of the second flow path tube is inserted into the insulating oil flowing channel arranged in the center of the corrugated fin block. That is, with the corrugated fin block coupled to the first and second flow path tubes, it can be seen that the connection portions are disposed on outer sides of the both first extensions and the both second extensions.

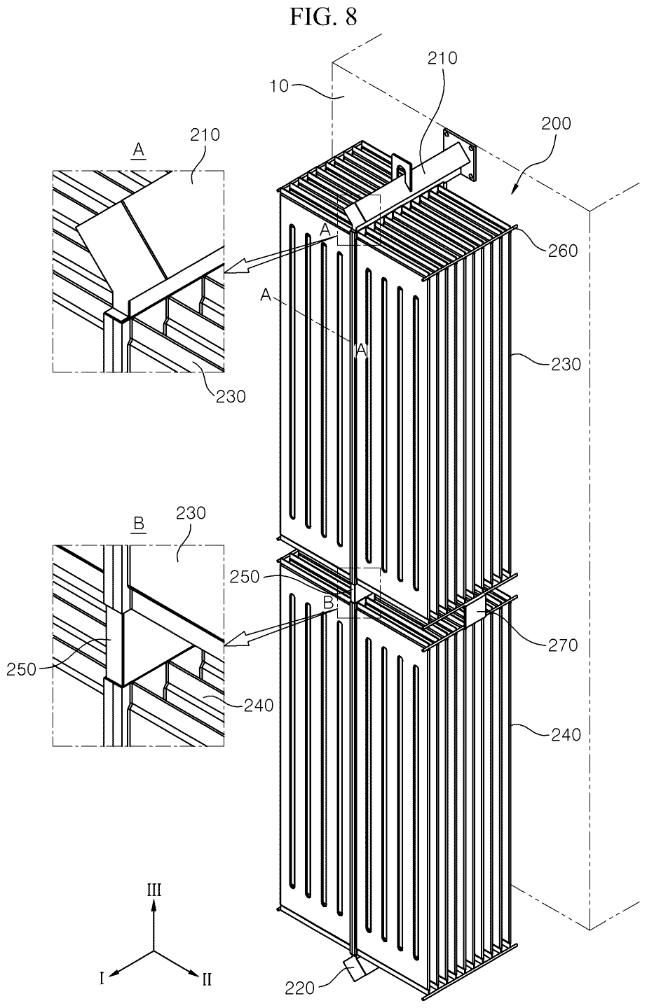

FIG. 8 is a view illustrating an overall configuration of a corrugated fin elongated radiator for a transformer according to the embodiment of the present invention.

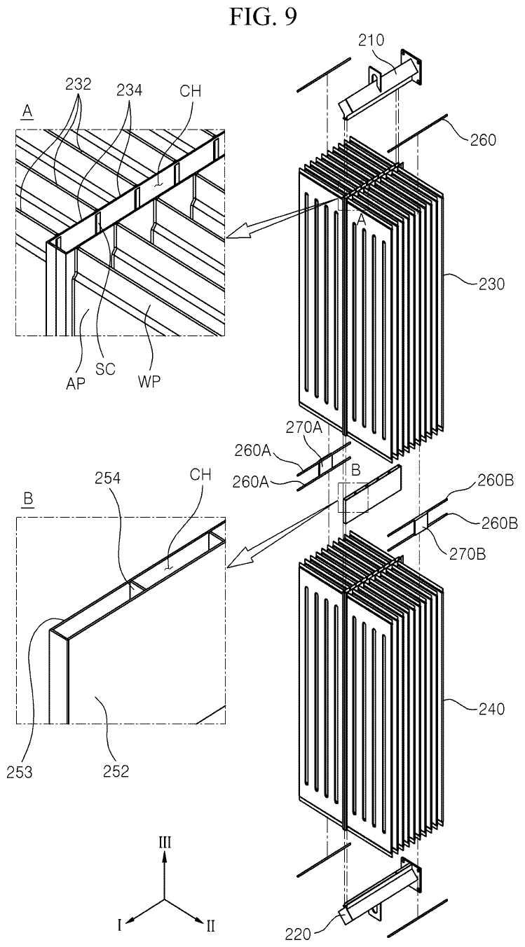

Further, FIG. 9 is an exploded view of the corrugated fin elongated radiator for a transformer according to the embodiment of the present invention.

With reference to FIGS. 8 and 9, a corrugated fin elongated radiator 200 for a transformer (hereinafter simply referred to as a “radiator”) may include a first flow path tube 210, a second flow path tube 220, a first corrugated fin block 230, a second corrugated fin block 240, a connection block 250, and an interval maintaining portion 260.

The first flow path tube 210 corresponds to the first flow path tube 110 described above in FIGS. 1 to 7. Likewise, the second flow path tube 220 corresponds to the second flow path tube 120 described above, the first corrugated fin block 230 corresponds to the corrugated fin block 130 described above, and the interval maintaining portion 260 corresponds to the interval maintaining portion 140 described above. That is, compared to the radiator described above in FIGS. 1 to 7, the radiator in FIGS. 8 to 9 is substantially the same except that the radiator in FIGS. 8 to 9 further includes the second corrugated fin block and the connection block, and thus the following description will focus on the differences.

The first and second corrugated fin blocks 230 and 240 are disposed between the first flow path tube 210 and the second flow path tube 220.

Further, the connection block 250 is disposed between the first and second corrugated fin blocks. As described below, the first corrugated fin block and the second corrugated fin block may be manufactured separately and then connected through the connection block. This enables fin length extension in units of blocks.

The present invention is described in terms of an embodiment with two corrugated fin blocks, but is not limited thereto, and an embodiment in which three or more corrugated fin blocks are disposed is also possible. When three or more corrugated fin blocks are disposed, it is sufficient to have two or more connection blocks disposed between the corrugated fin blocks. This will result in a longer fin length extension.

In the drawings, an embodiment is illustrated in which the first corrugated fin block is disposed at an upper portion and the second corrugated fin block is disposed at a lower portion. However, the first corrugated fin block and the second corrugated fin block have the same structure with only a difference in the disposed position, so that the following description will focus on a structure of the first corrugated fin block, which is one of the first corrugated fin block and the second corrugated fin block.

Each of the corrugated fin blocks 230 and 240 has an inner space communicating with the first flow path tube 210 and the second flow path tube 220 to receive the insulating oil (not illustrated).

The corrugated fin blocks each form an insulating oil flowing channel CH in a center thereof. Therefore, a circulation path is formed in which the insulating oil sequentially passes through the first flow path tube, the corrugated fin blocks, and the second flow path tube. That is, the insulating oil that gains heat from the transformer main body 10 exits the first flow path tube 210, passes through the corrugated fin blocks 230 and 240 to dissipate heat, and enters the transformer main body again through the second flow path tube 220 to circulate inside the radiator.

As previously described, the above description of the corrugated fin block in FIGS. 1 to 7 is equally applicable to the first corrugated fin block.

In addition, the description of the first corrugated fin block is equally applicable to the second corrugated fin block. The same description is possible for the first flow path tube and the second flow path tube, with only the disposition changed up and down. Therefore, a more detailed description is omitted.

The connection block 250 forms a space for receiving insulating oil between the corrugated fin blocks 230 and 240. The present invention is described with reference to an embodiment having one connection block because there are two corrugated fin blocks, but the present invention is not limited to the number.

The connection block has a structure with openings at an upper portion and a lower portion thereof. The connection block has an opening at the upper portion so that an inner space of the connection block communicates with the first corrugated fin block. The connection block has an opening at the lower portion so that an inner space of the connection block communicates with the second corrugated fin block. Therefore, a circulation path is formed in which the insulating oil sequentially passes through the first flow path tube, the first corrugated fin block, the connection block, the second corrugated fin block, and the second flow path tube.

To this end, the connection block may have two opposite plate portions 252 and 253 that form the upper and lower openings along the insulating oil flowing channel.

In addition, the connection block 250 may have a plurality of reinforcing ribs 254 therein. The reinforcing rib serves as structural reinforcement for the fin length extension in units of blocks. This takes into account that the connection block will support all the self-weight of the components disposed on top of the connection block.

The interval maintaining portion 260 is formed in the shape of a rod and coupled to the heat dissipation fins to allow the heat dissipation fins to maintain a predetermined interval.

As illustrated in the drawings, the interval maintaining portion may be disposed at each of edges of the corrugated fin blocks, thus a total of eight interval maintaining portions may be disposed. One interval maintaining portion may be disposed to be welded to all of the uppermost welded portions (WP, see FIG. 2) of each of the heat dissipation fins. When exposed to repeated expansion and contraction of the insulating oil (especially in transformers applied to solar power generators, where the power output can vary significantly over time), the original shape of the heat dissipation fins may not be maintained, and the interval between the heat dissipation fins may become distorted. To address this issue, the interval maintaining portion is disposed at this joining position with the least risk of insulating oil leakage on the heat dissipation fins manufactured through the press process using the mold, as described above. This enables the introduction of a more stable interval maintenance structure.

A reinforcing plate 270 is disposed in parallel with the connection block 260 to serve as structural reinforcement for the fin length extension structure in units of blocks. That is, it can be seen that the reinforcing plate 270 serves to assist in the structural reinforcement of the connection block.

In the first corrugated fin block, one coupled to an outer side of the first corrugated fin portion may be referred to as a first interval maintaining portion 260A and one coupled to an outer side of the second corrugated fin portion may be referred to as a second interval maintaining portion 260B. In the second corrugated fin block, one coupled to an outer side of the first corrugated fin portion may be referred to as the first interval maintaining portion 260A and one coupled to an outer side of the second corrugated fin portion may be referred to as the second interval maintaining portion 260B. In this case, the reinforcing plate may be coupled to the first interval maintaining portion 260A positioned at a lower side of the first corrugated fin block and the first interval maintaining portion 260A positioned at an upper side of the second corrugated fin block. In the self-weight supporting structure by the connection block described above, loads are distributed not only on the connection block but also on the reinforcing plate and interval maintaining portions. In the fin length extension structure in units of blocks, more solid structural rigidity may be secured.

When there are two connection blocks because there are three corrugated fin blocks, the reinforcing plate is also disposed every connection block, so that a total of four reinforcing plates may be disposed.

Meanwhile, the coupling relationship between the first flow path tube and the corrugated fin block described in FIG. 7 may be applied equally to the coupling relationship between the first flow path tube and the first corrugated fin block. Further, the coupling relationship may be equally applicable to the coupling relationship between the second flow path tube and the second corrugated fin block. That is, the second path tube may be coupled in such a way that a portion of the both second extensions of the second flow path tube is inserted into the insulating oil flowing channel arranged in the center of the second corrugated fin block. That is, when the first and second corrugated fin blocks are coupled to the first and second flow path tubes, it can be seen that the connection portions of the first corrugated fin block are disposed on outer sides of the both first extensions, and the connection portions of the second corrugated fin block are disposed on outer sides of the both second extensions.

This disposition relationship is also seen in a coupling relationship between the connection block and the corrugated fin blocks.

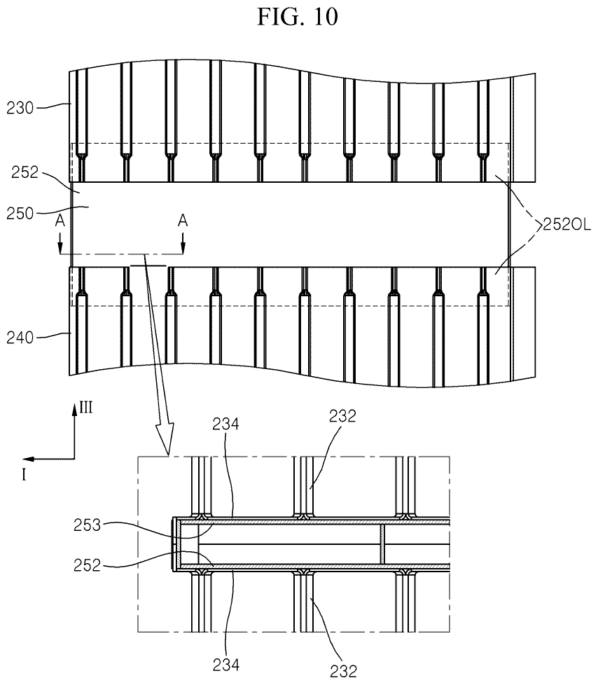

FIG. 10 is a view illustrating a coupling relationship between the connection block and the corrugated fin blocks according to the embodiment of the present invention.

With reference to FIG. 10, the connection block 250 may be coupled in a manner in which the connection block 250 is inserted into the first corrugated fin block 230 and the second corrugated fin block 240.

In detail, the two opposite plate portions 252 and 253 of the connection block may be coupled to the corrugated fin blocks in such a way that a portion of an upper side thereof is inserted into the insulating oil flowing channel arranged in the center of the first corrugated fin block 230, and a portion of a lower side thereof is inserted into the insulating oil flowing channel arranged in the center of the second corrugated fin block 240.

After being inserted, the first path tube may be firmly fixed by a physically joining method, such as welding or the like, or with a chemically joining method. For one example, the welding may be applied to outer surfaces of the connection portions that are disposed on the outside of the two opposite plate portions 252 and 253 that is in a state of being inserted into the insulating oil flowing channel.

An area overlapped by the insertion is referenced in the drawing by the reference numeral 2520L. Although not illustrated, there may be an equally overlapping area on the other side. The reference numeral 2520L is used to represent an element 252 that is disposed inside the connection portions.

With reference to an enlarged view according to a cross section taken along line AA in FIG. 10, the arrangement relationship between the two opposite plate portions 252 and 253 and the connection portion 234 of the first corrugated fin block in the insulating oil flowing channel can be seen. The two opposite plate portions may be inwardly attached to the connection portions. It is preferred that the connection portions and the two opposite plate portions are in close contact with each other so as to form a circulation path of the insulating oil.

This structure is advantageous for welding and joining the connection block to the corrugated fin blocks manufactured through the press process. That is, in consideration of the characteristics of the first corrugated fin block and the second corrugated fin block being molded integrally from the single panel, the both first plate portions of the connection block, which are a joining portion, are disposed inside the connection portions, so that the welding operation may be performed more easily.

In the enlarged view taken along line AA in FIG. 10, only the coupling relationship between the second corrugated block and the connection block is illustrated, but the same may be equally applicable to the coupling relationship between the first corrugated block and the connection block. That is, when the connection block is coupled to the first and second corrugated fin blocks, it can be seen that the connection portions of the first corrugated fin block and the connection portions of the second corrugated fin block are disposed on the outer sides of the two opposite plates.

While the present invention has been described above with reference to particular contents such as specific constituent elements, the limited embodiments, and the drawings, but the embodiments are provided merely for the purpose of helping understand the present invention overall, and the present invention is not limited to the embodiment, and may be variously modified and altered from the disclosure by those skilled in the art to which the present invention pertains. Accordingly, the spirit of the present invention should not be limited to the described embodiment, and all of the equivalents or equivalent modifications of the claims as well as the appended claims belong to the scope of the spirit of the present invention.

### DESCRIPTION OF REFERENCE NUMERALS

10: Transformer main body
100: Corrugated radiator for transformer
110: First flow path tube
112: Body portion
113: Lower closing portion
114: Closing portion
116: Flange portion
117: Loop portion
118 and 119: Both first extensions
120: Second flow path tube
130: Corrugated fin block
130A: First corrugated fin portion
130B: Second corrugated fin portion
132: Heat dissipation fin
134: Connection portions
132A: First heat dissipation fin
132B: Second heat dissipation fin
134A: First connection portion
134B: Second connection portion
140: Interval maintaining portion
200: Corrugated fin elongated radiator for transformer
210: First flow path tube
212: Body portion
213: Lower closing portion
214: Closing portion
216: Flange portion
217: Loop portion
218 and 219: Both first extensions
220: Second flow path tube
230: First corrugated fin block
230A: First corrugated fin portion
230B: Second corrugated fin portion
232: Heat dissipation fin
234: Connection portion
232A: First heat dissipation fin
232B: Second heat dissipation fin
234A: First connection portion
234B: Second connection portion
240: Second corrugated fin block
250: Connection block
252 and 253: Two opposite plate portions
254: Reinforcing rib
260: Interval maintaining portion
270: Reinforcing plate

1. A corrugated radiator for a transformer, comprising:
a first flow path tube configured to receive insulating oil from a transformer main body;
a second flow path tube through which the insulating oil, which has finished heat exchange with the outside, flows into the transformer main body; and
a corrugated fin block having an inner space communicating with the first and second flow path tubes and configured to receive the insulating oil,
wherein the corrugated fin block is formed so that connection portions connecting heat dissipation fins face each other to form a closed structure for circulating the insulating oil.

2. The corrugated radiator for a transformer of claim 1, wherein the connection portions form an insulating oil flowing channel between the first and second flow path tubes.

3. The corrugated radiator for a transformer of claim 2, wherein the corrugated fin block includes a first corrugated fin portion disposed on one side, and a second corrugated fin portion disposed on the other side with respect to the channel,
the connection portions include a first connection portion configured to integrally connect heat dissipation fins of the first corrugated fin portion, and a second connection portion configured to integrally connect heat dissipation fins of the second corrugated fin portion, and
the first connection portion and the second connection portion are disposed to face each other.

4. The corrugated radiator for a transformer of claim 3, wherein the connection portions further include a bent portion configured to integrally connect the first connection portion and the second connection portion.

5. The corrugated radiator for a transformer of claim 2, wherein the first flow path tube includes both first extensions configured to form a first opening along the channel,
the second flow path tube includes both second extensions configured to form a second opening along the channel, and
the connecting portions are disposed on outer sides of the both first extensions and the both second extensions in a state in which the corrugated fin block is coupled to the first and second flow path tubes.

6. The corrugated radiator for a transformer of claim 1, wherein the heat dissipation fin and the connection portions are integrally molded from a single panel and continuously formed.

7. The corrugated radiator for a transformer of claim 3, wherein the heat dissipation fins of the first corrugated fin portion and the heat dissipation fins of the second corrugated fin portion are arranged side by side with each other.

8. The corrugated radiator for a transformer of claim 3, wherein the heat dissipation fins of the first corrugated fin portion and the heat dissipation fins of the second corrugated fin portion are spaced apart from each other by a width of the channel.

9. The corrugated radiator for a transformer of claim 3, further comprising:
a first interval maintaining portion coupled to an outer side of the first corrugated fin portion to maintain a predetermined interval of the heat dissipation fins; and
a second interval maintaining portion coupled to an outer side of the second corrugated fin portion to maintain a predetermined interval of the heat dissipation fins.

10. A corrugated fin elongated radiator for a transformer, comprising:
a first flow path tube configured to receive insulating oil from a transformer main body;
a second flow path tube through which the insulating oil, which has finished heat exchange with the outside, flows into the transformer main body;
two or more corrugated fin blocks each having an inner space communicating with the first and second flow path tubes and configured to receive the insulating oil; and
one or more connection blocks configured to form a space to receive the insulating oil between the corrugated fin blocks.

11. The corrugated fin elongated radiator for a transformer of claim 10, wherein the corrugated fin blocks are formed so that connection portions connecting heat dissipation fins face each other to form a closed structure for circulating the insulating oil.

12. The corrugated fin elongated radiator for a transformer of claim 11, wherein the connection portions form an insulating oil flowing channel between the first and second flow path tubes.

13. The corrugated fin elongated radiator for a transformer of claim 12, wherein each of the corrugated fin blocks includes a first corrugated fin portion disposed on one side, and a second corrugated fin portion disposed on the other side with respect to the channel,
the connection portions include a first connection portion configured to integrally connect heat dissipation fins of the first corrugated fin portion, and a second connection portion configured to integrally connect heat dissipation fins of the second corrugated fin portion, and
the first connection portion and the second connection portion are disposed to face each other.

14. The corrugated fin elongated radiator for a transformer of claim 13, wherein the connection portions further include a bent portion configured to integrally connect the first connection portion and the second connection portion.

15. The corrugated fin elongated radiator for a transformer of claim 13, wherein the first flow path tube includes both first extensions configured to form a first opening along the channel,
the second flow path tube includes both second extensions configured to form a second opening along the channel, and
the connection block includes two opposite plate portions configured to form a third opening and a fourth opening facing the third opening along the channel.

16. The corrugated fin elongated radiator for a transformer of claim 13, wherein the connecting portions are disposed on outer sides of the both first extensions and the both second extensions in a state in which the corrugated fin blocks are coupled to the first and second flow path tubes, and
the connecting portions are disposed on outer sides of the two opposite plates in a state in which the connection block is coupled to the corrugated fin blocks.

17. The corrugated fin elongated radiator for a transformer of claim 10, wherein the heat dissipation fin and the connection portions are integrally molded from a single panel and continuously formed.

18. The corrugated fin elongated radiator for a transformer of claim 13, wherein the heat dissipation fins of the first corrugated fin portion and the heat dissipation fins of the second corrugated fin portion are arranged side by side with each other.

19. The corrugated fin elongated radiator for a transformer of claim 13, wherein the heat dissipation fins of the first corrugated fin portion and the heat dissipation fins of the second corrugated fin portion are spaced apart from each other by a width of the channel.

20. The corrugated fin elongated radiator for a transformer of claim 13, further comprising:
a first interval maintaining portion coupled to an outer side of the first corrugated fin portion to maintain a predetermined interval of the heat dissipation fins; and
a second interval maintaining portion coupled to an outer side of the second corrugated fin portion to maintain a predetermined interval of the heat dissipation fins.

21. The corrugated fin elongated radiator for a transformer of claim 20, further comprising a reinforcing plate disposed side by side with the connection block,
wherein the reinforcing plate is coupled to the first interval maintaining portion of any one of the two or more corrugated fin blocks and the first interval maintaining portion of the other one of the two or more corrugated fin blocks to support a self-weight.

22. The corrugated fin elongated radiator for a transformer of claim 10, wherein the connection block has a plurality of reinforcing ribs therein.
